(19) United States
(12) Patent Application Publication
(10) Pub. No.: US 2003/0176104 A1
(43) Pub. Date: Sep. 18, 2003

(54) Apparatus and method for electrical connector cable retention

(76) Inventors: John W. Hall, Harrisburg, PA (US); James M. Raudenbush, Halifax, PA (US); Douglas J. Hardy, Middletown, PA (US); Keith R. Foltz, Oberlin, PA (US)

Correspondence Address: Joseph A. Tessari, Esquire, TYCO TECHNOLOGY RESOURCES, 4550 New Linden Hill Road-Suite 450, Wilmington, DE, 19808-2952, US

(21) Appl. No.: 10/098,098

(22) Filed: Mar. 13, 2002

(51) Int. Cl. H01R 13/60

(52) U.S. Cl. 439/575

(57) ABSTRACT

Apparatus and method for electrical connector cable retention are shown, comprised of a FAKRA connector with cable retention means. The retention means is comprised of an extended housing with a means for retaining a cable, which in the preferred embodiments is either comprised of a groove-projection assembly integrated with the extended housing or an cable clip external to the extended housing. Various embodiments provide for varying cable diameters.

### FIELD OF THE INVENTION

This invention relates to apparatus, methods and articles of manufacture for electrical connectors. More particularly, this invention relates to apparatus, methods and articles of manufacture for electrical connectors for cables and printed circuit boards.

### BACKGROUND OF THE INVENTION

Cable to cable connectors and printed circuit board (PCB) to cable connectors may be standardized according to various schemes. One standardization scheme commonly used in automotive applications is referred to as FAKRA. The FAKRA standardization scheme provides specific key and color codes for desired SMB connections.

Eleven specific key and color codes exist in the current FAKRA standard for SMB connectors. These eleven specific types provide eleven specified arrangements of ribs and recesses on jacks that mate with complementary plugs. Thus, any improvement of a specific FAKRA type must be carefully done so as not to interfere with the FAKRA specified arrangement for that type.

Yet, and despite the success of the FAKRA standardization scheme, improvement is desirable. For example, often multiposition cable assemblies are used in automotive and other applications. A multiposition cable assembly comprises more than one cable with more than one connector. Using multiposition cable assemblies permits less disorder in cable runs through the application as the cables are contained within one fairly contiguous group. However, multiposition cable assemblies take more room, e.g. require larger holes, to pass through bulk heads, walls, etc., than single cables. As a general matter, smaller rather than larger holes for cable runs are desirable in automotive and other applications because of safety and other considerations. Thus, multiposition cable assemblies, despite their use in minimizing cable disorder, create their own difficulties.

It would be desirable therefore when using FAKRA connectors in multiposition cable assemblies to have some mechanism for minimizing space requirements.

It would further be desirable to simplify FAKRA connections in multiposition cable assemblies. For example, when a multiposition cable assembly terminates in a number of FAKRA connections, each FAKRA connector on the assembly may be more difficult to install than a similar number of FAKRA connectors on individual cables because the connectors may not be spaced enough, the entire assembly may be too unwieldy, etc. Therefore, it would be desirable to provide a simple method of organizing FAKRA connectors in a multiposition cable assembly.

Accordingly, it is an object of the present invention to provide methods, apparatus and articles of manufacture for minimizing space requirements in FAKRA multiposition cable assemblies.

It is a further object of the present invention to provide methods, apparatus and articles of manufacture for simplifying FAKRA organization in multiposition cable assemblies.

It is a further object of the present invention to provide methods, apparatus and articles of manufacture for minimizing space requirements in FAKRA multiposition cable assemblies and simplifying FAKRA organization in multiposition cable assemblies without deviating from the FAKRA standardization scheme.

### SUMMARY OF THE INVENTION

The present invention comprises connector apparatus, methods and articles of manufacture for minimizing space requirements in FAKRA cable assemblies and simplifying FAKRA organization in cable assemblies without deviating from the FAKRA SMB standardization scheme. The preferred embodiments are used with FAKRA jack housings in multiposition cable assemblies, for connecting the jack housings to mating plug housings for cables and printed circuit boards.

The components of the preferred embodiments comprise a FAKRA jack housing with cable retention means. The cable retention means provides a structure to retain additional cables, i.e., those not terminating in the FAKRA jack housing to which the retention means is connected. Various embodiments provide for varying cable diameters.

Upon assembly of a cable assembly with at least one FAKRA connector, the embodiments provide retention of at least one other cable to the device. The preferred embodiments provide cable retention in a multiposition cable assembly with at least one FAKRA connector without altering the necessary FAKRA standardized components and dimensions. Thus, embodiments may be used for any of the current eleven specific types, as well as for any other specific FAKRA SMB connectors, such as new standardized types, etc. Moreover, any desired audible and tactile feedback—assuring the FAKRA connection has been established—is maintained.

### BRIEF DESCRIPTION OF THE DRAWINGS

FIG. 1 shows prior art.

FIG. 2 shows prior art.

FIG. 3 shows a plan view of a preferred embodiment.

FIG. 4 shows another view of the embodiment of FIG. 3.

FIG. 5 shows a sectional view taken along line V-V of FIG. 3.

FIG. 6 shows another view of the embodiment of FIG. 3.

FIG. 7 shows a plan view of another embodiment.

FIG. 8 shows a plan view of another preferred embodiment.

FIG. 9 shows another view of the embodiment of FIG. 8.

FIG. 10 shows another view of the embodiment of FIG. 3.

FIG. 11 shows another view of the embodiment of FIG. 8.

### DETAILED DESCRIPTION OF THE PREFERRED EMBODIMENTS

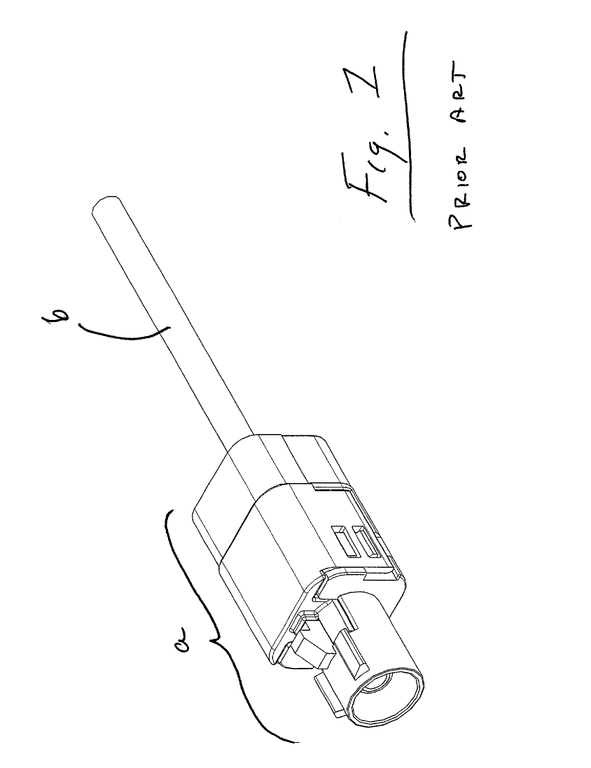

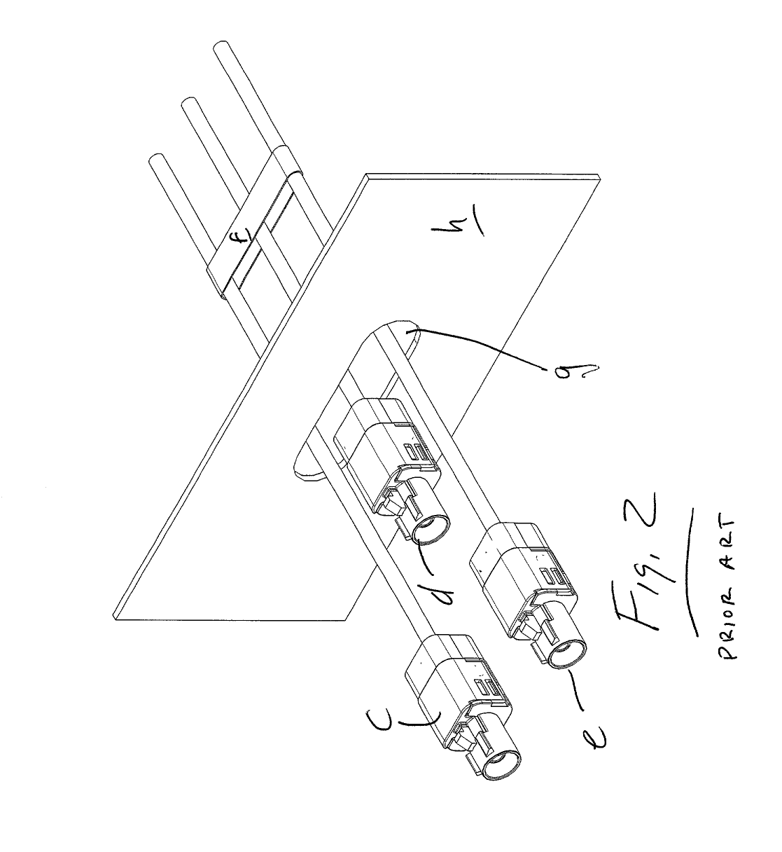

FIG. 1 shows, generally at a, a typical prior art FAKRA connector that terminates cable b. FIG. 2 shows a typical prior art multiposition cable assembly, terminating in prior art FAKRA connectors, c, d and e. The individual cables are retained by retainer f. The assembly passes through hole h in bulkhead g.

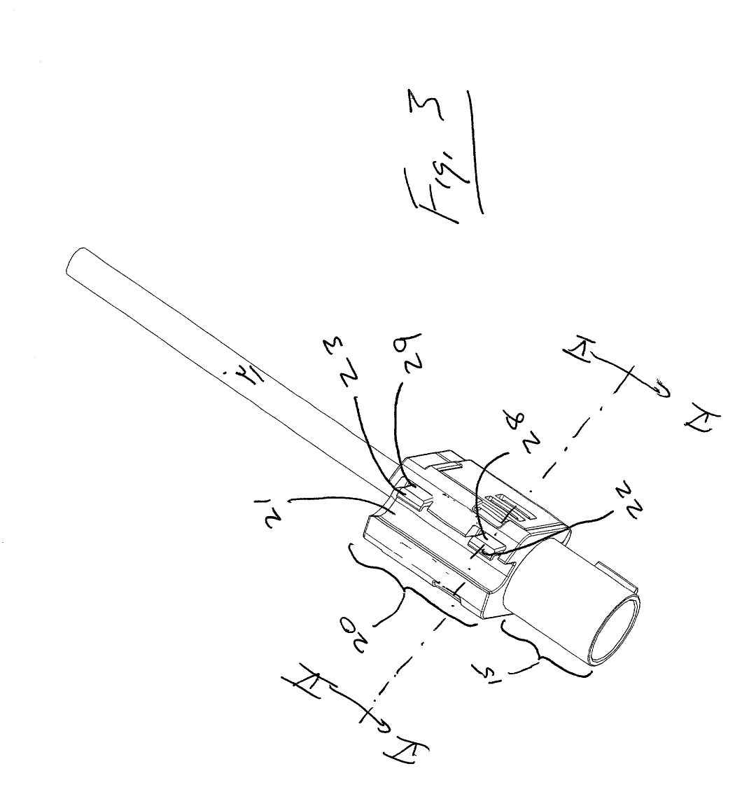

FIG. 3 shows a preferred embodiment, installed on cable i, of the present invention. Front section 15 is configured as desired, i.e., according to the desired FAKRA code. Thus, front section 15 may take on a number of desired configurations. Rear section 20, which is referred to herein as an “extended housing,” comprises the cable retention means.

In this embodiment, groove 21 in extended housing 20 provides at least partial retention for a second cable (not shown.) The beams 22 and 23 also provide at least partial retention for a second cable. The beams 22 and 23 extending into the groove 21 are active beams, that is, they are constructed so as to flexibly retain a second cable of various diameters, by flexing into recesses 28 and 29 respectively when a cable is placed within the groove and beams. The larger the cable diameter, the greater the degree of outward flex of the beams. It should be noted that, in this embodiment, the preferable cable diameter is such so as to contact at least the lips of beams 22 and 23 as well as part of groove 21, as is further described below.

It should be noted that, in other embodiments, a greater or lesser number of beams is used as desired. Moreover, the beams do not have to be placed on the same side of an extended housing in those embodiments, but may be placed on opposite sides of an extended housing.

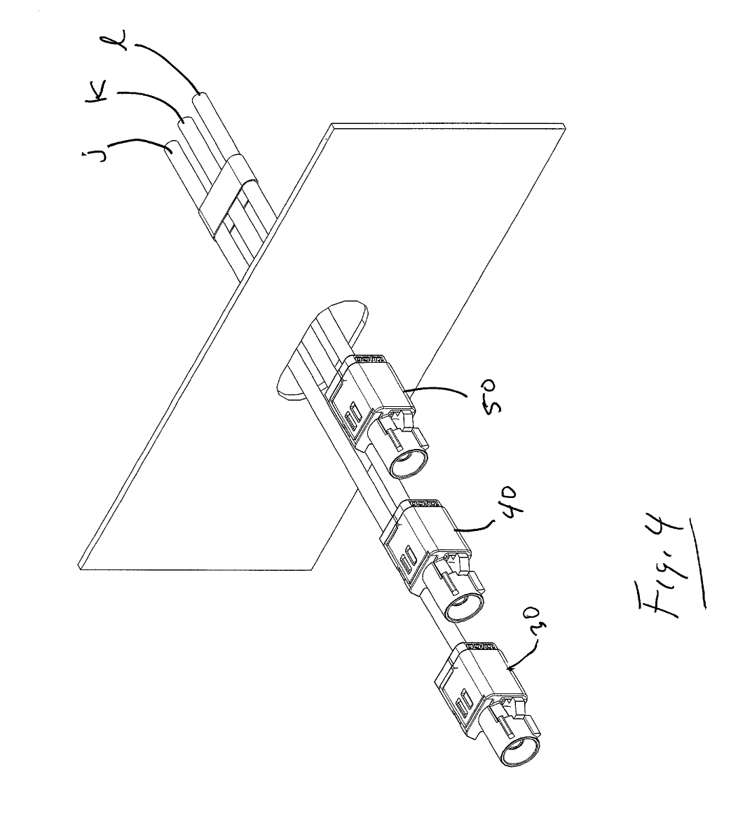

Turning now to FIG. 4, embodiments 30, 40 and 50, as in FIG. 3, are shown installed upon a multiposition cable harness. Cables j, k and l are shown with embodiments 40 and 50 providing retention of cables j and k respectively.

It should be noted that the various preferred embodiments provide snap in and out positioning of cables, that is, installation of the cable on an embodiment is not permanent, but rather a cable can be installed and/or removed as desired.

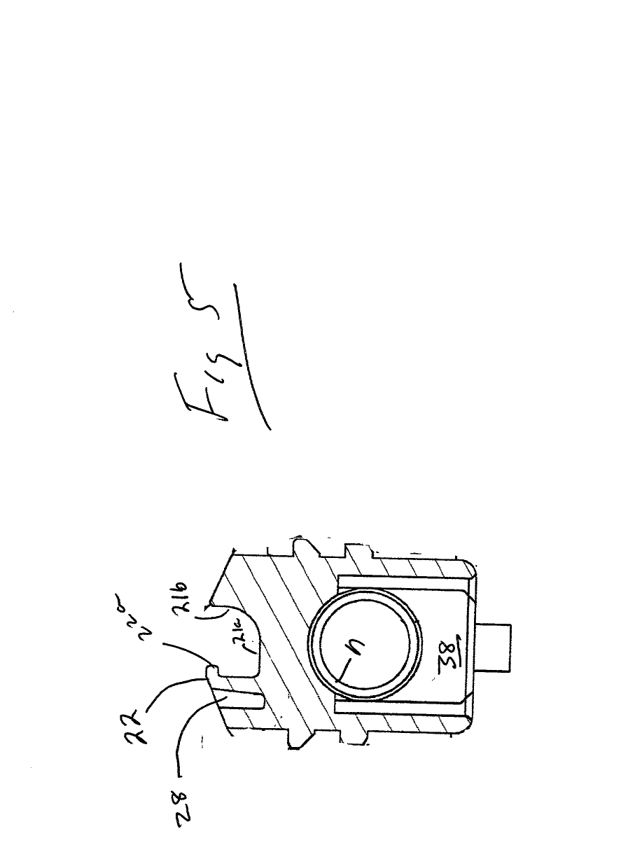

FIG. 5 shows a view along line V-V of FIG. 3. Beam 22 extends upwardly from the floor 21a of groove 21. Beam 22 is active or resilient and pivots off its base, into recess 28 as the cable is placed into groove 21. The beam will then usually pivot at least partially back, depending upon the cable diameter, although desired retention may exist with no pivoting back of beam 22. Cables are of varying diameter (although usually of standardized diameter for an SMB connection, ranging from RG-178 to RG-58) and so when a cable within this standardized range is fit within this section of groove 21, it will make contact with at least part of floor 21a, wall 21b and lip 22a of beam 22. Also shown in the figure is outer contact subassembly n, as well as retention saddle 38, which is internal to the extended housing of this embodiment and retains the outer contact subassembly n, within the extended housing.

Turning now to FIG. 6, two pieces 35 and 36 of the embodiment of FIG. 3 are shown. Top 35 fits over bottom piece 36. Tabs 41 and 43 fit within slots 42 and 44 respectively to secure each piece to the other, and to provide a positive snap fit for the connection of the pieces. Beams 22 and 23 are shown as well. Seen through the slot 42 is a leg of retention saddle 38.

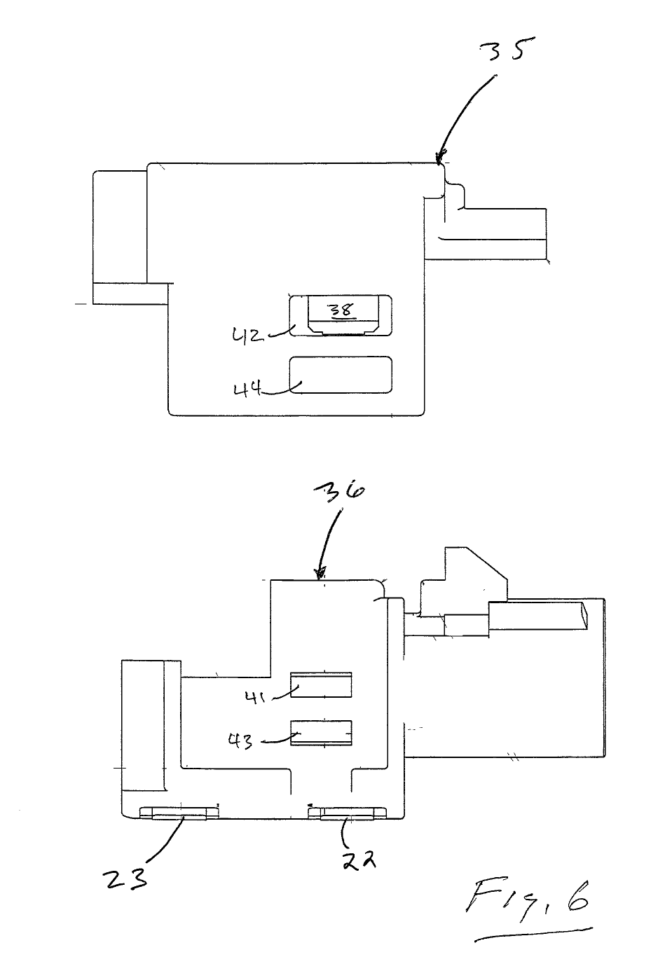

FIG. 7 shows another embodiment. Groove 51 in extended housing 55 provides at least partial retention for a second cable (not shown.) Tabs 52 and 53, extending into groove 51, also provide at least partial retention for a second cable. This embodiment may be used for cables of a known diameter. By varying the groove diameter and tab dimensions, cables of varying diameter can be accommodated. Moreover, in other embodiments, a greater or lesser number of tabs is used as desired. Moreover, the tabs do not have to be placed on the same side of an extended housing in those embodiments, but may be placed on opposite sides of an extended housing.

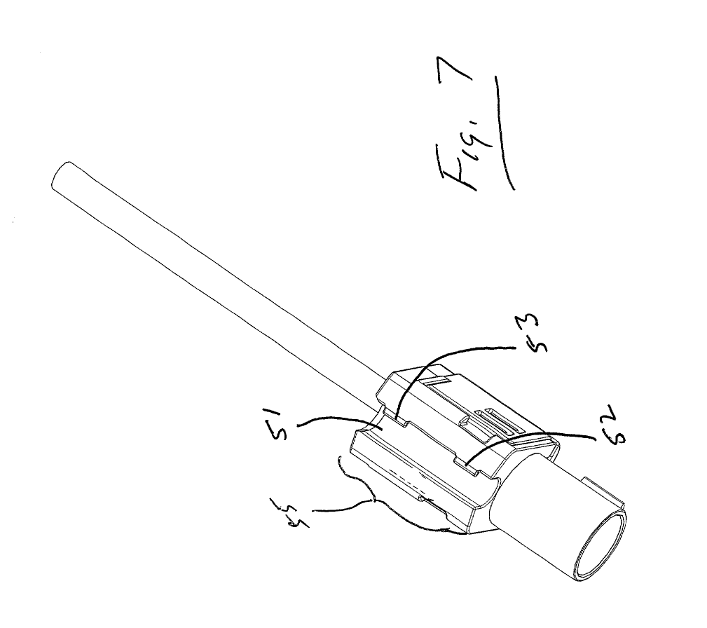

FIG. 8 shows yet another embodiment. Here a cable clip 61 depends downwardly from an extended housing of connector 60. The clip provides retention for another cable. The range of diameters accommodated by a clip may be from RG-178 to RG-58. A greater or lesser range of cable diameters may also be accommodated through varying clip size.

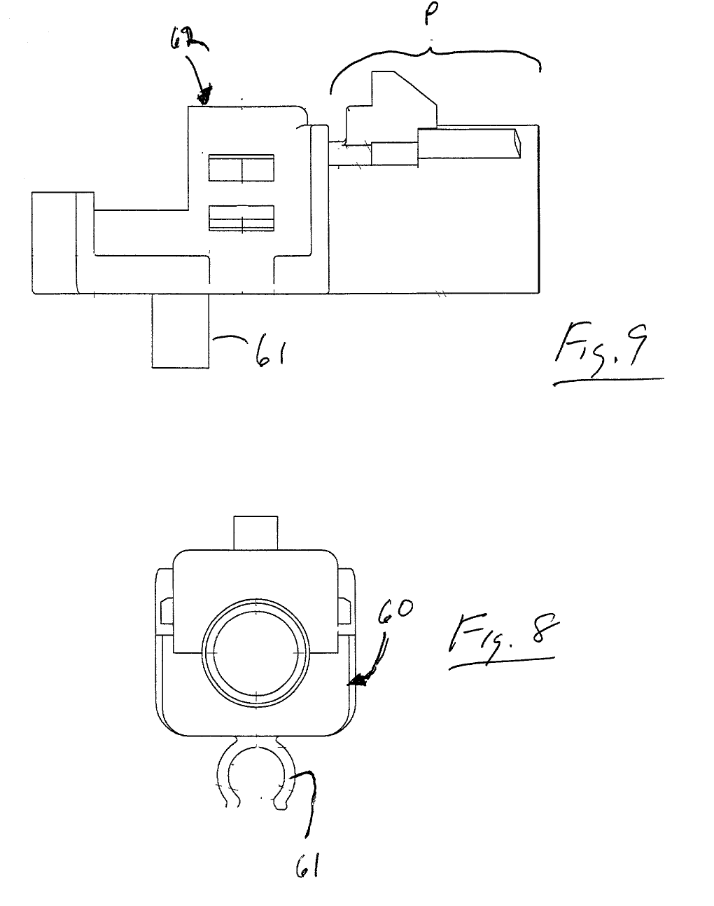

A side view of the bottom piece of the embodiment of FIG. 8 is shown in FIG. 9. Area p is a FAKRA connector of any specific type. Clip 60 depends from housing 62. Clip 60 may be formed or otherwise attached to extended housing 62. In other embodiments, a clip might be interchangeable, or replaceable, as desired.

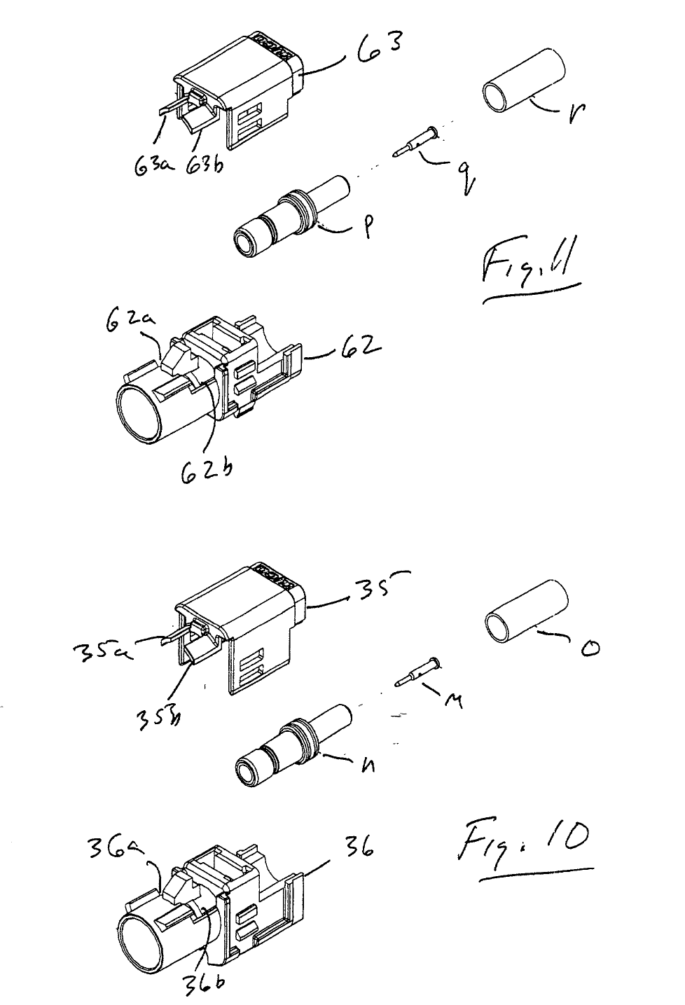

FIGS. 10 and 11 show the components of the embodiments of FIGS. 3 and 8 respectively. Top piece 35 and bottom piece 36 surround contact m, outer contact subassembly n, comprised of an outer contact and dielectric, and ferrule o, and are shown in FIG. 10. In FIG. 11, top piece 62 and bottom piece 63 surround outer contact subassembly p, contact q, comprised of an outer contact and dielectric, and ferrule r. Although these embodiments are shown with a male connector, other embodiments maybe used with a female connector as desired.

It should be noted that in the embodiments of both FIGS. 10 and 11, extension members are provided on the top piece that fit into corresponding recesses on the bottom piece without interference with the FAKRA coding scheme (i.e., extension members 35a fits into recess 35a, and 35b fits into recess 36b in FIG. 10; and extension members 63a and 63b fit into recesses 62a and 62b respectively.)

Use of an embodiment with retention means integrated into an extended housing, for example, the embodiments of FIGS. 3 and 7, may provide a more streamlined, smaller assembly, which can be used in tighter confines. However, use of an embodiment with retention means external to an extended housing, e.g. the embodiment of FIG. 8, may provide more flexibility in installing and removing any cable.

In other embodiments, the retention means may depend from other areas of an extended housing, e.g. either side of an extended housing. Additionally, embodiments may be used in multiple position FAKRA housings, as well as single FAKRA housings.

It should also be noted that embodiments may be used with FAKRA connectors that are not in multiposition assemblies. Thus, FAKRA connectors as modified by these embodiments may be used where organizing multiple cable runs may be desired.

The various elements are made of materials such as are known in the art. For example an embodiment of the present invention may be constructed from Polybutylene Terephtlatate (PBT) or other similar materials.

The above description and the views and material depicted by the figures are for purposes of illustration only and are not intended to be, and should not be construed as, limitations on the invention.

Moreover, certain modifications or alternatives may suggest themselves to those skilled in the art upon reading of this specification, all of which are intended to be within the spirit and scope of the present invention as defined in the attached claims.

1. An electrical connector comprising:
a FAKRA complaint connector with an extended housing depending therefrom; and,
a cable retention means integrated with said extended housing.

2. An electrical connector as in claim 1 wherein said cable retention means further comprises:
a first retention means;
a second retention means;

3. An electrical connector as in claim 2 wherein said first retention means further comprises a groove in said extended housing.

4. An electrical connector as in claim 3 wherein said second retention means further comprises a projection extending into said groove.

5. An electrical connector as in claim 4 wherein said projection extending into said groove further comprises a beam extending into said groove.

6. An electrical connector as in claim 5 wherein said beam extending into said groove further comprises an active beam extending into said groove.

7. An electrical connector as in claim 4 wherein said projection extending into said groove further comprises a tab extending into said groove.

8. An electrical connector comprising:
a FAKRA complaint connector with an extended housing depending therefrom; and,
a cable retention means depending from said extended housing.

9. An electrical connector as in claim 8 wherein said cable retention means further comprises a cable clip.

10. A method for connecting cables to an electrical connector comprising the steps of:
providing a FAKRA complaint connector with an extended housing depending therefrom, and a cable retention means integrated with said extended housing;
inserting a cable in said retention means.

11. A method as in claim 10 wherein the step of providing a FAKRA complaint connector with an extended housing depending therefrom, and a cable retention means integrated with said extended housing, further comprises the step of providing a cable retention means comprised of a first retention means and a second retention means.

12. A method as in claim 11 wherein the step of providing cable retention means comprised of a first retention means and a second retention means further comprises the step of providing a first retention means comprised of a groove in said extended housing.

13. A method as in claim 12 wherein the step of providing cable retention means comprised of a first retention means and a second retention means further comprises the step of providing a second retention means comprised of a projection extending into said groove.

14. A method as in claim 13 wherein the step of providing a second retention means comprised of a projection extending into said groove further comprises the step of providing a beam extending into said groove.

15. A method as in claim 14 wherein the step of providing a beam extending into said further comprises the step of providing an active beam extending into said groove.

16. A method as in claim 13 wherein the step of providing a second retention means comprised of a projection extending into said groove further comprises the step of providing a tab extending into said groove.

17. A method for connecting cables to an electrical connector comprising the steps of:
providing a FAKRA complaint connector with an extended housing depending therefrom, and a cable retention means depending from said extended housing;
inserting a cable in said retention means.

18. A method as in claim 17 wherein the step of providing a FAKRA complaint connector with an extended housing depending therefrom, and a cable retention means depending from said extended housing, further comprises the step of providing a cable retention means comprised of a cable clip.
